(19) United States
(12) Patent Application Publication
(10) Pub. No.: US 2009/0261215 A1
(43) Pub. Date: Oct. 22, 2009

(54) Intravenous pole and base protection system

(76) Inventor: Donald Lambert, Westwood, MA (US)

Correspondence Address: LAMBERT & ASSOCIATES, P.L.L.C., 92 STATE STREET, BOSTON, MA, 02109-2004, US

(21) Appl. No.: 12/082,950

(22) Filed: Apr. 16, 2008

(51) Int. Cl. F16M 13/00

(52) U.S. Cl. 248/125.8; 248/346.5; 248/177.1

(57) ABSTRACT

An intravenous base and pole protection system having a upper portion, a middle portion and a lower portion, wherein each portion comprises a single solitary unit that protects the spoke and wheel assembly of an IV pole from hanging liquids and/or from becoming entangled with surrounding wires.

### BACKGROUND OF THE INVENTION

1. Field of the Invention

The instant invention relates generally to protection devices for wheel and spoke assemblies, and in particular to an intravenous pole and base protection system wherein the system prevents the spokes and wheels from not only becoming entangled in stationary objects such as wire and cables, but simultaneously prevents any liquid solutions from coming in contact with the base assembly.

2. Description of the Related Art

The use of intravenous (“IV”) poles is widespread in the medical industry, specifically in hospital and assisted-living facilities, wherein one of the many functions of these poles is to hold caustic liquids, such as saline, blood and blood products, for use by a patient. Furthermore, there are a variety of base assemblies, which consist of spoke and wheel assemblies that support the IV pole; in practice, the most common and well-known IV poles include a base containing anywhere from four to six spokes with a corresponding number of wheels attached to each spoke. In addition, most IV poles are locatable in settings that contain numerous wires running throughout the room and connecting to a variety of machines, whether in the operating or emergency room. As a result, it is very common for wires to become entangled in not only the wheels, but also the spokes of the IV pole. This occurrence presents numerous hazards ranging from causing the pole to lose stability, to accidentally unplugging a machine, along with creating the inability to maneuver the pole into a desired location or position. Moreover, not only do the numerous wires present a problem to the maneuverability of the IV pole, additionally, the liquids that are hung from the top of the pole also create a problem, as these liquids often soil the base and wheels by dripping on them. Once these liquids collect under the spokes, where they are likely to go unnoticed, they are very difficult to clean up. Also, in the case of blood and blood products, these additionally pose a biological hazard to the individual responsible for cleaning the IV pole base. Thus, biological materials that are not completely removed from the base, or the wheels, represent a nutrient source for bacteria to grow in, thereby polluting a portion of an operating room and potentially promoting the spread of infection.

The use of wheel guards or similar systems, for the protection of individual wheels from entanglement with a multitude of devices, including but not limited to wires, cables and tubing is known in the art. These wheel guard systems are designed to protect individual wheels from becoming entangled with surrounding wires thereby limiting movement of a device, such as an IV pole. Medical facilities, specifically hospitals, employ wheelable machines that need to traverse the numerous wires when moving from one location to the next.

The instant invention relates to a protection system for wheel and spoke assemblies, preferably locatable on IV poles that prevent the device from becoming entangled with wires and also from coming into contact with any liquids during use. Many devices have been developed to prevent individual wheels of a device from becoming entangled with wires or similar materials during transport of the device, especially for machines commonly used in a medical setting. Ultimately, it is the design goal for such an apparatus to provide a protection system that prevents a device such as an IV pole from becoming entangled with wires, along with preventing any contact from liquids, wherein the system protects the entire base structure instead of individual wheel components.

Presently, there are several wheel guard systems that employ a variety of means to avoid having the wheels of a device become entangled in wires or other like materials. One of the most common types of devices for protecting individual wheels of a device involves placing a cylindrical device around an individual wheel thereby prevent wires from coming into contact with the wheel. However, this system only protects an individual wheel of a device and furthermore, only protects the wheel from obstructions directly in front, there is no protection for the top surface of the wheel. Furthermore, such devices as an IV pole include a spoke and wheel assembly at the base of the pole, thus simply protecting each individual wheel does not prevent the structure from becoming entangled with wires, along with failing to protect from any liquids that may drip on the base. Moreover, the present systems only protect individual wheel assembly and have no means of incorporating the systems to cover entire base structures; the present systems are mainly applicable to only one specific wheel design or to one distance between the base of a machine and the floor, thus causing multiple systems to be used to handle a variety of devices and wheel structures.

A large number of wheel protections are known in the art, and in fact are in wide use in the industry. But there exists in the art no protection system that provides relief from entanglement with wires along with protecting against contact with liquids, wherein the system protects the entire base structure, preferably of an IV pole, rather than individual wheel compartments.

U.S. Pat. No. 5,873,144 to Tupper, et al. discloses a one-piece roll guard having two half segments connected by an integral hinge for protecting a caster wheel by clearing obstacles away from its rolling path. The two segments of the roll guard are closed and secured together around the caster wheel with a locking tab and matching locking slot integrally formed in the two segments.

U.S. Pat. No. 5,615,450 to Butler, discloses a skirt system for caster wheels to prevent a rolling caster from colliding with floor debris, wherein the skirt assembly is fastened to a caster having a swiveling housing in which the housing is mounted on a caster wheel on an axle, thereby allowing the skirt to swivel with the caster.

U.S. Pat. No. 6,854,159 to Ruitenbeek, discloses a swivel caster suitable to be mounted in a transportation system wherein the caster includes a wheel secured on a shaft by means of a first roller bearing, the shaft being attached near its ends to the legs of a swivel fork having a body or supporting element connected with a casing of a second roller bearing such that the casing can be mounted on the transportation system.

U.S. Pat. No. 6,678,917 to Winters, et al. discloses a wheel protection system for moving a hose or cable on a working surface away from the wheels of a movable device, such as a portable welder, wherein the system includes a separate wheel guard positioned to at least partially surround each wheel of the movable device; and independently mounted by a structure that allows the wheel guard to deflect upward upon contacting an irregularity on the working surface.

U.S. Pat. No. 5,702,117 to Geelhoed, discloses a trolley intended for a medical apparatus and comprising wheels for displacement on a floor surface wherein the wheels are provided with a cable pusher having a pushing edge, the pusher containing a plate with approximately triangular cut-outs which receive stationary cams.

U.S. Pat. No. 5,371,920 to Rainville, discloses a safety system of roll guards protecting an anesthesia machine's wheel assemblies from being obstructed or snagged by objects lying upon a floor surface or dangling above the floor surface that are in the path of movement, wherein each roll guard is loosely connected to part of the wheel assembly or anesthesia machine, and has a vertically upstanding cylindrical portion whose bottom rests upon the floor surface.

In summary, investigation of these disclosed devices illustrates that presently, there is no single device known in the art or combination thereof that meets the requirements of a single protection system that simultaneously prevents all wheel and spoke assemblies, preferably for an IV pole from becoming entangled with wires or coming into contact with liquids that may pose a biological hazard, wherein the protection system enables protection of the entire base structure and may accommodate a variety of wheel and spoke sizes.

### SUMMARY OF THE INVENTION

The instant invention, as described further herein, imparts a novel protection system for an entire IV pole base, including the spokes and wheels from caustic liquids among other things which encompasses the advantages of other protection systems, but also includes a cover in addition to a bottom sleeve to encompass the entire base structure rather than individual components, such as each wheel or spoke, while being able to accommodate a variety of size and models of IV poles. The instant invention as illustrated herein, is clearly not anticipated, rendered obvious, or even present in any of the prior art mechanisms, either alone or in any combination thereof.

The primary object of the instant invention is to provide a protection system capable of encompassing the entire base of an IV pole, wherein the system includes a bottom sleeve and a cover to protect the spoke and wheel assembly from caustic liquids among other things.

Another object of the instant invention is to provide a protection system capable of encompassing the entire base of an IV pole, wherein the system is adjustable in size to allow an individual the option to utilize the system on different makes, models and sizes of IV poles and bases to protect poles presently in use.

Another object of the instant invention is to provide a protection system capable of encompassing the entire base of an IV pole, wherein the system eliminates the need for individual wheel guards to prevent entanglement of the base with wires and like material; instead the instant invention allows for the entire base of the pole to be surrounded by the bottom sleeve and the cover, thereby using a single system to ensure protection and coverage.

Another object of the instant invention is to provide a protection system capable of encompassing the base of an IV pole, wherein the system not only protects against the entanglement of wheels with wires and similar materials, but simultaneously protects against entanglement of spokes with wires, since the system includes a bottom sleeve and cover that eliminates access to the spoke and wheel assembly.

There has thus been outlined, rather broadly, the more important features of the apparatus for protection of an IV pole base assembly in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a diagrammatic perspective view of the IV pole and base protection system shown in the closed position, wherein the system includes an upper portion having a substantially cylindrical opening, a middle portion having a substantially trapezoidal shape and a lower portion having a substantially cylindrical shape.

FIG. 2 is a diagrammatic perspective view of the IV pole and base protection system shown in the open position for mating with an IV pole, wherein the system contains a single seam having a plurality of interlocking tab units to assist during use and non-use of the system.

FIG. 3 is a diagrammatic perspective view of the IV pole and base protection system shown with the interlocking tab units.

FIG. 4 is a diagrammatic perspective view of one of the individual interlocking tab units of the protection system, wherein a tab and lock mechanism work in conjunction to ensure a proper seal of the protection system when in use.

FIG. 5 is a diagrammatic perspective view of the single seam having a plurality of interlocking tab units to assist with alignment and stabilization of the system.

FIG. 6 is a diagrammatic perspective view of one of the IV pole and base protection system in use, wherein the system is received by an IV pole to ensure protection from both liquids along with preventing any entanglement with nearby wires.

### DETAILED DESCRIPTION OF THE PREFERRED EMBODIMENTS

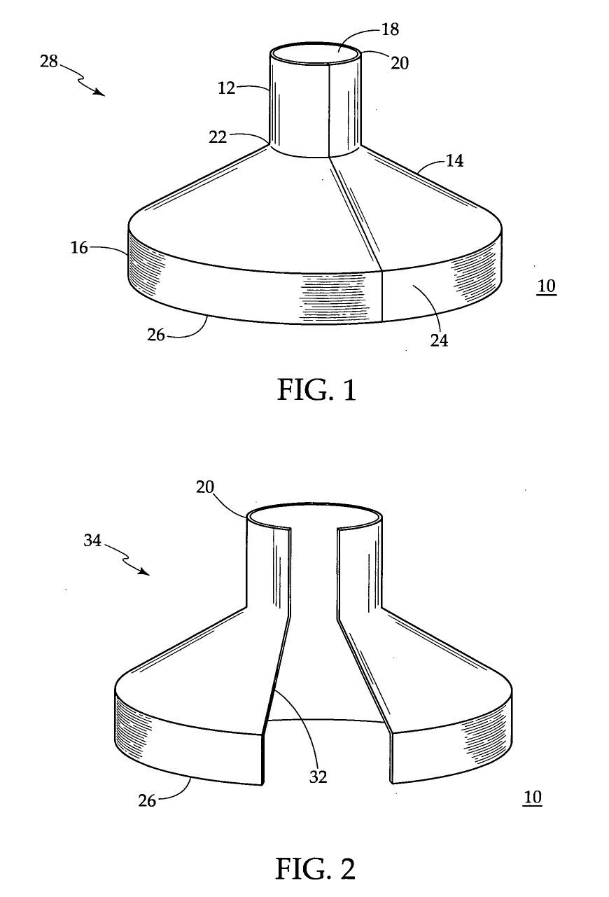

FIG. 1 illustrates an intravenous (“IV”) base and pole protection system 10 having an upper portion 12, a middle portion 14 and a lower portion 16, wherein each portion comprises a single solitary unit that protects the spoke and wheel assembly of an IV pole from hanging liquids. A secondary function of the protection system 10 is to prevent the entire spoke and wheel assembly of the IV pole from becoming entangled with surrounding wires, preferably when the system is being utilized in a medical setting, such as a hospital operating room. The upper portion 12 of the protection system 10 includes a cylindrical opening 18 located at the top 20 of the upper portion 12, wherein the cylindrical opening 18 preferably extends downwardly following the contour of a standard IV pole until the upper portion 12 interacts with a mid-section 22 of the system 10. The protection system 10 preferably extends outwardly and slopes downwardly from the mid-section 22 until the middle portion 14 of the system 10 reaches the lower portion 16 of the system 10. The lower portion 16 of the system includes a top 24, wherein once the middle portion 14 of the system reaches the top 24 of the lower portion 16, the lower portion 16 preferably extends downwardly to a base 26. Furthermore, in the preferred embodiment the top 20 of the upper portion extending downwardly to the mid-section 22 of the system, creates a tight seal around an intra-venous pole to prevent any liquids from penetrating the spoke and wheel assembly of the IV pole that may be hanging during use of the protection system 10.

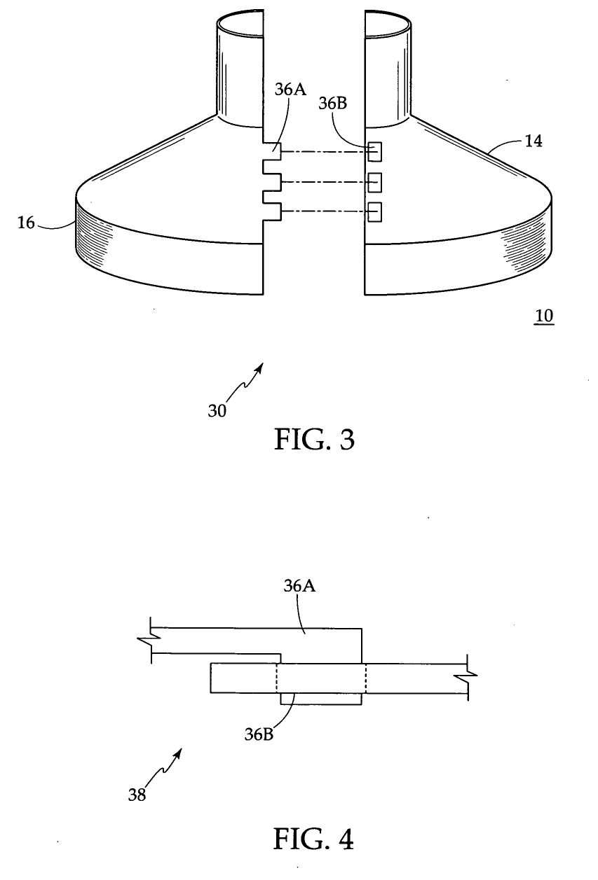

The protection system 10 is shown in the closed position 28 wherein the system 10 forms a single unit to preferably surround the base of an IV pole that consists of a spoke and wheel assembly. In the preferred embodiment the system 10 is one solitary unit that does not require opening or closing for use. In an alternate embodiment, the system 10 utilizes a plurality of interlocking units 30 (see FIGS. 3 & 4) to open and close the system 10 for operation. Furthermore, preferably in all embodiments that the system 10 utilizes the locking units 30, the protection system 10 includes a single seam 32 (see FIG. 2) to assist in the opening and closing of the system during coupling with the IV pole assembly.

In the preferred embodiment shown in FIG. 1, the system 10 includes a cylindrical upper portion 12, a middle portion 14 that is conical in shape and extends outwardly to cover the circumference of a standard spoke and wheel assembly associated with an IV pole. The preferred comprising a cylindrical lower portion 16 in communication with the middle portion 14. In alternate embodiments, the middle portion 14 may comprise different structural shapes depending on the individual need for the system 10 and/or preference by a user. Potential shapes for the middle portion 14, include but are not limited to rectangular, domed, triangular, conical and circular. Furthermore, while both the upper portion 12 and lower portion 14 are preferably cylindrical in shape, these portions may contain different structural shapes in alternate embodiments, to possibly give the overall protection system 10 a uniform shape, including but not limited to rectangular, domed, conical and triangular.

FIG. 2 illustrates an alternate embodiment of the IV pole and base protection system 10 wherein the system 10 is shown in the open position 34 wherein the single seam 32 from the top 20 of the upper portion 12 of the protection system 10 to the base 26. A plurality of interlocking units 30 (see FIG. 3) are locatable and preferably equidistantly disposable along the seam 32 to facilitate transitioning the system between the open position 28 and closed position 34 during coupling and/or removal from a standard IV pole.

FIG. 3 illustrates the embodiment of the protection system 10 having the single seam 32 along with the plurality of interlocking units 30 locatable along the seam. Each interlocking unit 30 preferably consists of a two-part system for opening and closing the base protection system 10, wherein a substantially extendable tab 36A couples with a corresponding tab receptacle 36B. While the preferred embodiment of the present invention utilizes a tab and lock system, alternate systems including, but not limited to a hook and fastener, Velcro®, magnetic, swage interlocks or any other coupling system known in the art is contemplated for use with the base protection system 10.

FIG. 4 illustrates one of the interlocking units 30, wherein the present embodiment includes the extendable tab 36A and the tab receptacle 36B working in conjunction to open and close the system 10. In this illustration, the extendable tab 36A is locatable in the tab receptacle 36B wherein the extendable tab 36A has been received by the tab receptacle 36B and is in the locked position 38. Preferably the extendable tab 36B is rectangular or hexagonal in shape such that when the interlocking unit is in the locked position 38, the extendable tab 36A will remain locatable in the tab receptacle 36B preferably through friction and other like properties between the extendable tab 36A and the tab receptacle 36B due to the shape and structure of the design.

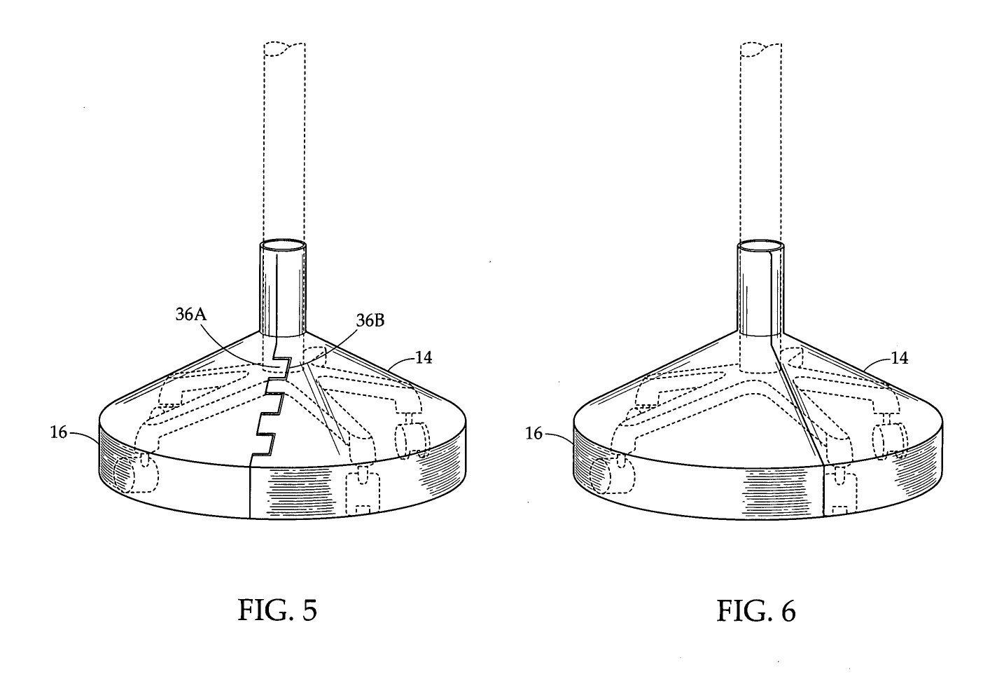

FIG. 5 illustrates the single seam 32 of the instant invention, wherein the seam is preferably utilized for aligning and stabilizing the system 10, while simultaneously preventing liquids from penetrating any portion of the system 10, thereby protecting the spoke and wheel assembly.

FIG. 6 illustrates the IV pole and base protection system 10 in use with a standard IV pole, along with a standard wheel and spoke assembly attachable to the base of the IV pole such that the protection system 10 completely encompasses the base of the IV pole. Therefore, the present system 10 allows for protection of a standard spoke and wheel assembly locatable on the base of the IV pole from any liquids that may be hanging on the pole and potentially drip onto the spoke and wheel assembly. Furthermore, the present system 10 allows for ease of movement by eliminating the potential for entanglement with surrounding wires.

While several embodiments of the instant invention have been illustrated by way of example, it is apparent that further embodiments could be developed within the spirit and scope of the instant invention. However, it is to be expressly understood that such modifications and adaptations are within the spirit and scope of the instant invention, as set forth in the following claims.

What is claimed is:

1. A protection system comprising:
an upper portion having a top;
a middle portion having a mid-section, wherein the upper portion extends downwardly from the top of the upper portion and interfaces to the mid-section; and
a lower portion having a top and a base, wherein the mid-section of the middle portion extends downwardly from the top of the lower portion and through the base of the lower portion.

2. The protection system of claim 1, further comprising a cylindrical opening locatable at the top of the upper portion, wherein the cylindrical opening extends downwardly to the mid-section of the middle portion.

3. The protection system of claim 2, further comprising a single seam extending downwardly from the top of the upper portion to the base of the lower portion.

4. The protection system of claim 3, wherein the system further includes an open position and a closed position.

5. The protection system of claim 4, further comprising a plurality of interlocking units equidistantly disposable along the seam to facilitate transitioning the system between the open position and closed position.

6. The protection system of claim 5, wherein each interlocking unit comprises a substantially extendable tab for coupling with a corresponding tab receptacle for opening and closing the protection system.

7. The protection system of claim 6, wherein the upper portion of the system is cylindrical, wherein the middle portion of the system is conical and wherein the lower portion is cylindrical in shape.

8. The protection system of claim 7, wherein the system allows for protection of a standard spoke and wheel assembly locatable on the base of the IV pole from any liquids that may be hanging on the pole and potentially drip onto the spoke and wheel assembly.

9. An intravenous base and pole protection system having a spoke and wheel assembly locatable at the base of the pole, comprising:
an upper portion having a top;
a middle portion having a mid-section, wherein the upper portion extends downwardly from the top of the upper portion to the mid-section; and
a lower portion having a top and a base, wherein the mid-section of the middle portion extends downwardly from the top of the lower portion and through the base of the lower portion.

10. The base and pole protection system of claim 9, further comprising a cylindrical opening locatable at the top of the upper portion, wherein the cylindrical opening extends downwardly to the mid-section of the middle portion.

11. The base and pole protection system of claim 10, further comprising a single seam extending downwardly from the top of the upper portion to the base of the lower portion.

12. The base and pole protection system of claim 11, wherein the system further includes an open position and a closed position.

13. The base and pole protection system of claim 12, further comprising a plurality of interlocking units equidistantly disposable along the seam to facilitate transitioning the system between the open position and closed position.

14. The base and pole protection system of claim 13, wherein each interlocking unit comprises a substantially extendable tab for coupling with a corresponding tab receptacle for opening and closing the protection system.

15. The base and pole protection system of claim 14, wherein the upper portion of the system is cylindrical, wherein the middle portion of the system is trapezoidal and extends outwardly to cover the circumference of the spoke and wheel assembly, and wherein the lower portion is cylindrical in shape.

16. The base and pole protection system of claim 15, wherein the system allows for protection of a standard spoke and wheel assembly locatable on the base of the IV pole from any liquids that may be hanging on the pole and potentially drip onto the spoke and wheel assembly.

17. A tri-component intravenous protection system comprising:
an upper component;
a middle component; and,
a lower component, wherein said upper component is in communication with said middle component and said middle component is in communication with said lower component; and,
wherein said upper component, said middle component and said lower component are disposed to meet the contours of an intravenous pole and base.

18. The tri-component intravenous protection system of claim 17, wherein the upper component of the system is cylindrical, wherein the middle portion of the system is trapezoidal and extends outwardly to cover the circumference of the spoke and wheel assembly, and wherein the lower component is cylindrical in shape.
